(19) United States
(12) Patent Application Publication
(10) Pub. No.: US 2025/0062050 A1
(43) Pub. Date: Feb. 20, 2025

(54) Superconductor-metal Conductive Material and the Electronic Component and the Method Using the Same

(71) Applicant: UBRIGHT OPTRONICS CORPORATION, Taoyuan City (TW)

(72) Inventors: WEN CHUN CHIU, Taoyuan City (TW); CHENG MING LIN, Taoyuan City (TW); LUNG-PIN HSIN, Taoyuan City (TW)

(21) Appl. No.: 18/805,555

(22) Filed: Aug. 15, 2024

Related U.S. Application Data
(60) Provisional application No. 63/532,917, filed on Aug. 16, 2023.

(51) Int. Cl. H01B 1/20; H01B 13/00; H01C 7/10; H01C 17/06

(52) U.S. Cl. CPC H01B 1/20; H01B 13/0036; H01C 7/10; H01C 17/06

(57) ABSTRACT

The invention discloses a superconductor-metal conductive material, comprising a metal powder, a superconductor powder and an organic carrier adhesive, wherein the metal powder has 50-95 wt % of a total weight of said metal powder, said superconductor powder and said organic carrier binder, the superconductor powder has 4-40 wt % of said total weight, and the organic carrier binder has 1-10 wt % of said total weight, wherein the superconductor powder comprises one or more mixtures of La2-x-ySrxBayCuO4, La2-x-y BixSryCuO4, La2-x-y-z BixSryCaZCuO4, La2-x-y-z HgxBayCazCuO4, La2-x-ySrxTlyBazCuO6, La2-x-y-z-wSrxTlyBazCawCu2O8, and HgBa2Ca2Cu3O8, where each of x, y, z, and w is between 0.1 and 0.9.

### CROSS-REFERENCE TO RELATED APPLICATIONS

This application claims the benefit of U.S. provisional patent application No. 63/532,917, filed on Aug. 16, 2023, which is hereby incorporated herein by reference.

### BACKGROUND OF THE INVENTION

### 1. Field of the Invention

The present invention relates to an electrical component, and more particularly to a passive electrical component. The invention belongs to the field of resistance materials, and particularly relates to a conductive oxide-metal conductive material and a preparation method thereof.

### 2. Description of Related Art

With the development of modern electronic industry, information industry, and high-tech technologies, the demand for conductive composite materials is continuously increasing, and conductive composite materials are receiving more and more attention. Research on conductive composite materials is mainly focused on conductive polymer composites, while studies using superconducting powder as conductive filler are relatively few. As electronic components are used in more demanding environments, special selection and design of internal or external conductive materials are required.

In the existing passive components (MLCC, varistors, thermistors, chip inductors), most failures in ultra-low temperature environments below 223K are due to the inability to effectively input current into the components. Additionally, the mismatch of expansion coefficients leads to discontinuity between the conductor layer and the ceramic layer, resulting in structural damage and electrical failure of the components. Therefore, there is an urgent need to develop passive components that can be used at specific ultra-low temperatures.

Accordingly, the present invention proposes a new solution to overcome the above-mentioned disadvantages.

### SUMMARY OF THE INVENTION

The first objective of this invention is to provide a superconductor-metal conductive material.

The second objective of this invention is to provide a method for preparing an the aforementioned superconductor-metal conductive material.

The third objective of this invention is to provide an electronic component that includes the aforementioned superconductor-metal conductive material.

This invention offers the advantage of improving the reliability of passive component products in harsh low-temperature environments. Additionally, by replacing glass powder with superconducting oxide and using the expansion coefficient of the superconducting oxide to adjust the expansion coefficient of the metal composite slurry formed by the metal conductor, the material can be matched with ceramic materials. This not only reduces the impedance of the metal composite slurry but also increases reliability at both low and high temperatures.

In one embodiment, the present invention discloses a superconductor-metal conductive material, comprising a metal powder, a superconductor powder and an organic carrier adhesive, wherein the metal powder has 50˜95 wt % of a total weight of said metal powder, said superconductor powder and said organic carrier binder, the superconductor powder has 4˜40 wt % of said total weight, and the organic carrier binder has 1-10 wt % of said total weight, wherein the superconductor powder comprises one or more mixtures of La2-x-ySrxBayCuO4, La2-x-y BixSryCuO4, La2-x-y-z BixSryCaZCuO4, La2-x-y-z HgxBayCazCuO4, La2-x-ySrxTlyBazCuO6, La2-x-y-z-wSrxTlyBazCawCu2O8, HgBa2Ca2Cu3O8, where each of x, y, z, and w is between 0.1 and 0.9.

In one embodiment, the average particle size of the superconductor powder is 30 nm to 300 nm.

In one embodiment, the metal powder includes one or more mixtures of Au, Ag, Cu, Sn, Ag/Pd, Pd, Al, Nb, Ti, and Ni.

In one embodiment, the average particle size of the metal powder is 30 nm to 2 μm.

In one embodiment, the particle size of the metal powder is less than 100 nm for 10-20%, and the remainder is between 100 nm and 2 μm for 80-90%.

In one embodiment, the organic carrier adhesive comprises one or more mixtures of polyvinyl butyral, ethyl cellulose, polyvinyl acetate, polyethylene oxide, carboxymethyl cellulose, styrene-butadiene rubber, polyacrylic acid, and polymethyl methacrylate.

In one embodiment, the superconductor-metal conductive material further comprises a organic solvent, wherein the organic solvent is one or more mixtures of toluene, alcohol, butyl acetate, ethylene glycol monobutyl ether, diethylene glycol monobutyl ether, and terpineol.

In one embodiment, the present invention discloses an electronic component, comprising: a plurality of composite layers stacked together, wherein each composite layer comprises a ceramic layer and a conductive layer made of a superconductor-metal conductive material is coated on the ceramic layer, wherein the superconductor-metal conductive material, comprising a metal powder, a superconductor powder and an organic carrier adhesive, wherein the metal powder has 50˜95 wt % of a total weight of said metal powder, said superconductor powder and said organic carrier binder, the superconductor powder has 4˜40 wt % of said total weight, and the organic carrier binder has 1-10 wt % of said total weight.

In one embodiment, the superconductor powder comprises one or more mixtures of La2-x-ySrxBayCuO4, La2-x-y BixSryCuO4, La2-x-y-z BixSryCaZCuO4, La2-x-y-z HgxBayCazCuO4, La2-x-ySrxTlyBazCuO6, La2-x-y-z-wSrxTlyBazCawCu2O8, HgBa2Ca2Cu3O8, where each of x, y, z, and w is between 0.1 and 0.9.

In one embodiment, the average particle size of the superconductor powder is 30 nm to 300 nm.

In one embodiment, the metal powder includes one or more mixtures of Au, Ag, Cu, Sn, Ag/Pd, Pd, Al, Nb, Ti, and Ni.

In one embodiment, the average particle size of the metal powder is 30 nm to 2 μm.

In one embodiment, the particle size of the metal powder is less than 100 nm for 10-20% of all of the particles of the metal powder, and the particle size of the metal powder is between 100 nm and 2 μm for 80-90% of all of the particles of the metal powder.

In one embodiment, the present invention discloses a method for forming a ceramic electronic component, comprising: coating a superconductor-metal conductive material on a ceramic layer to form a composite layer; stacking multiple composite layers together and sintering the stacked multiple composite layers at a temperature above 800° C. to obtain the ceramic electronic component.

In one embodiment, the superconductor-metal conductive material, comprising a metal powder, a superconductor powder and an organic carrier adhesive, wherein the metal powder has 50˜95 wt % of a total weight of said metal powder, said superconductor powder and said organic carrier binder, the superconductor powder has 4˜40 wt % of said total weight, and the organic carrier binder has 1-10 wt % of said total weight.

In one embodiment, the superconductor powder comprises one or more mixtures of La2-x-ySrxBayCuO4, La2-x-y BixSryCuO4, La2-x-y-z BixSryCaZCuO4, La2-x-y-z HgxBayCazCuO4, La2-x-ySrxTlyBazCuO6, La2-x-y-z-wSrxTlyBazCawCu2O8, HgBa2Ca2Cu3O8, where each of x, y, z, and w is between 0.1 and 0.9.

In one embodiment, the superconductor-metal conductive material is formed by following steps: mixing 50-95 weight percentage of metal powder and 4-40 weight percentage of superconductor powder; adding 1-10 weight percentage of organic carrier adhesive to the mixed powder; adding the mixture into a solvent containing dispersant to obtain the superconductor-metal conductive material.

The detailed technology and above preferred embodiments implemented for the present invention are described in the following paragraphs accompanying the appended drawings for people skilled in this field to well appreciate the features of the claimed invention.

### BRIEF DESCRIPTION OF THE DRAWINGS

The foregoing aspects and many of the accompanying advantages of this invention will become more readily appreciated as the same becomes better understood by reference to the following detailed description when taken in conjunction with the accompanying drawings, wherein:

FIG. 1 illustrates a schematic of a plurality of ceramic layers and conductive layers in an embodiment of the present invention;

FIG. 2 illustrates a schematic of an electronic component in an embodiment of the present invention;

FIG. 3 illustrates a schematic of an electronic component in an embodiment of the present invention;

FIG. 4 illustrates a schematic 3D view of an electronic component in an embodiment of the present invention; and

FIG. 5 illustrates a schematic 3D view of an electronic component in an embodiment of the present invention.

### DETAILED DESCRIPTION OF THE ILLUSTRATED EMBODIMENTS

The detailed explanation of the present invention is described as follows. The described preferred embodiments are presented for purposes of illustrations and descriptions, and they are not intended to limit the scope of the present invention.

The present invention provides a superconductor-metal conductive material, comprising the following components: a metal powder, a superconductor powder and an organic carrier adhesive, wherein the metal powder has 50˜95 wt % of a total weight of superconductor-metal conductive material, the superconductor powder has 4˜40 wt % of the total weight of superconductor-metal conductive material, and the organic carrier adhesive has 1-10 wt % of the total weight of superconductor-metal conductive material, wherein the superconductor powder comprises one or more of the following mixtures: La2-x-ySrxBayCuO4, La2-x-y BixSryCuO4, La2-x-y-z BixSryCaZCuO4, La2-x-y-z HgxBayCazCuO4, La2-x-ySrxTlyBazCuO6, La2-x-y-z-wSrxTlyBazCawCu2O8, and HgBa2Ca2Cu3O8, where each of x, y, z, and w is between 0.1 and 0.9.

In one embodiment, the average particle size of the superconductor powder is 30 nm to 300 nm.

In one embodiment, the metal powder includes one or more mixtures of Au, Ag, Cu, Sn, Ag/Pd, Pd, Al, Nb, Ti, and Ni.

In one embodiment, the average particle size of the metal powder is 30 nm to 2 μm.

In one embodiment, the particle size of the metal powder is <100 nm for 10-20%, and the remainder is between 100 nm and 2 μm for 80-90%.

In one embodiment, the organic carrier adhesive includes one or more mixtures of polyvinyl butyral, ethyl cellulose, polyvinyl acetate, polyethylene oxide, carboxymethyl cellulose, styrene-butadiene rubber, polyacrylic acid, and polymethyl methacrylate.

In one embodiment, the superconductor-metal conductive material further includes a solvent, which comprises an organic solvent or a water solvent, where the organic solvent is one or more mixtures of toluene, alcohol, butyl acetate, ethylene glycol monobutyl ether, diethylene glycol monobutyl ether, and terpineol.

In one embodiment, the superconductor-metal conductive material further includes a dispersant, which comprises one or more mixtures of carboxylic acid type, long-chain alkyl amino acid type, polyacrylic acid type, and polymethyl methacrylate type.

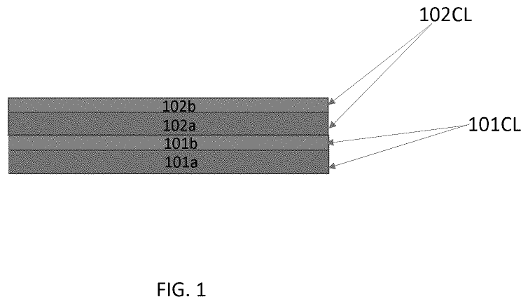

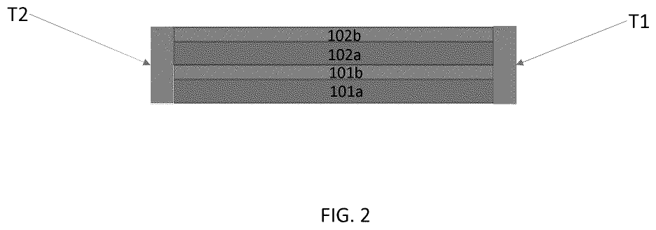

FIG. 1 illustrates a schematic of a plurality of ceramic layers and conductive layers of an electronic component in an embodiment of the present invention, and FIG. 2 illustrates a schematic of an electronic component in an embodiment of the present invention, wherein the electronic component comprises a plurality of composite layers 101CL, 102CL stacked together, wherein a first composite layer 101CL comprises a first ceramic layer 101a and a first conductive layer 101b made of a superconductor-metal conductive material is coated on the first ceramic layer 101a, and a second composite layer 102CL comprises a second ceramic layer 102a and a second conductive layer 102b made of a superconductor-metal conductive material is coated on second ceramic layer 102a, wherein the superconductor-metal conductive material comprises a metal powder, a superconductor powder and an organic carrier adhesive, wherein the metal powder has 50˜95 wt % of a total weight of said metal powder, said superconductor powder and said organic carrier binder, the superconductor powder has 4˜40 wt % of said total weight, and the organic carrier binder has 1-10 wt % of said total weight.

In one embodiment, the superconductor powder comprises one or more of the following mixtures: La2-x-ySrxBayCuO4, La2-x-y BixSryCuO4, La2-x-y-z BixSryCaZCuO4, La2-x-y-z HgxBayCazCuO4, La2-x-ySrxTlyBazCuO6, La2-x-y-z-wSrxTlyBazCawCu2O8, and HgBa2Ca2Cu3O8, where each of x, y, z, and w is between 0.1 and 0.9.

In one embodiment, the electronic component is a resistor having two terminals T1, T2.

In one embodiment, the first conductive layer 101b comprises a plurality of conductive patterns.

In one embodiment, thee second conductive layer 102b comprises a plurality of conductive patterns.

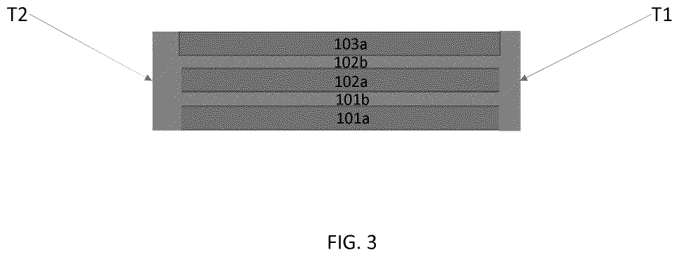

FIG. 3 illustrates a schematic of an electronic component in an embodiment of the present invention, wherein a third ceramic layer 103a is disposed on second conductive layer 102b of the electronic component in FIG. 2. In one embodiment, the electronic component is a resistor having two terminals T1, T2.

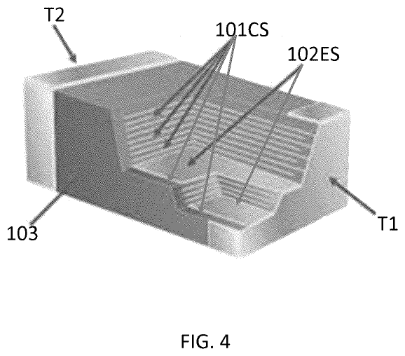

FIG. 4 illustrates a schematic 3D view of an electronic component in an embodiment of the present invention, wherein the electronic component comprises a plurality of ceramic layers 101CS and a plurality of conductive layers 102ES, wherein a conductive layer made of a superconductor-metal conductive material is coated on a corresponding ceramic layer. In one embodiment, the electronic component is a resistor having two terminals T1, T2.

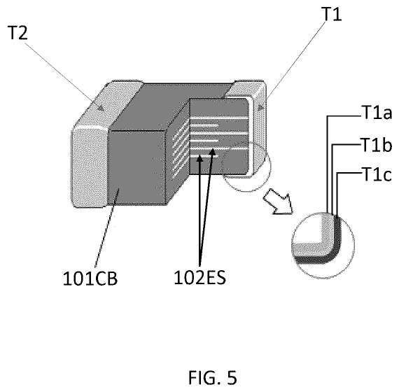

FIG. 5 illustrates a schematic 3D view of an electronic component in an embodiment of the present invention, wherein the electronic component comprises a ceramic body 101CB having a plurality of ceramic layers 101CS, wherein a plurality of conductive layers 102ES are disposed in the ceramic body 101CB, wherein a conductive layer made of a superconductor-metal conductive material is coated on a corresponding ceramic layer. In one embodiment, the electronic component is a resistor having two terminals T1, T2.

In one embodiment, the terminal T1 has three layers, wherein the innermost layer T1a is made of Ag, the middle layer is made of NI, and the outermost layer T1a is made of Sn.

In one embodiment, the terminal T2 has three layers, wherein the innermost layer T1a is made of Ag, the middle layer is made of NI, and the outermost layer T1a is made of Sn.

In one embodiment, the present invention discloses an electronic component, comprising: a plurality of composite layers stacked together, wherein each composite layer comprises a dielectric layer and a conductive layer made of a superconductor-metal conductive material is coated on the dielectric layer, wherein the superconductor-metal conductive material, comprising a metal powder, a superconductor powder and an organic carrier adhesive, wherein the metal powder has 50˜95 wt % of a total weight of said metal powder, said superconductor powder and said organic carrier binder, the superconductor powder has 4˜40 wt % of said total weight, and the organic carrier binder has 1-10 wt % of said total weight.

In one embodiment, the superconductor powder comprises one or more of the following mixtures: La2-x-ySrxBayCuO4, La2-x-y BixSryCuO4, La2-x-y-z BixSryCaZCuO4, La2-x-y-z HgxBayCazCuO4, La2-x-ySrxTlyBazCuO6, La2-x-y-z-wSrxTlyBazCawCu2O8, and HgBa2Ca2Cu3O8, where each of x, y, z, and w is between 0.1 and 0.9.

In one embodiment, the average particle size of the superconductor powder is 30 nm to 300 nm.

In one embodiment, the metal powder includes one or more mixtures of Au, Ag, Cu, Sn, Ag/Pd, Pd, Al, Nb, Ti, and Ni.

In one embodiment, the average particle size of the metal powder is 30 nm to 2 μm.

In one embodiment, the particle size of the metal powder is <100 nm for 10-20%, and the remainder is between 100 nm and 2 μm for 80-90%.

In one embodiment, the electronic component is a resistor.

In one embodiment, the electronic component is a varistor.

In one embodiment, the present invention discloses a method for forming a ceramic electronic component, comprising: coating a superconductor-metal conductive material on a ceramic layer to form a composite layer; stacking multiple composite layers together and sintering the stacked multiple composite layers at a temperature above 800° C. to obtain the ceramic electronic component.

In one embodiment, the superconductor-metal conductive material, comprising a metal powder, a superconductor powder and an organic carrier adhesive, wherein the metal powder has 50˜95 wt % of a total weight of said metal powder, said superconductor powder and said organic carrier binder, the superconductor powder has 4˜40 wt % of said total weight, and the organic carrier binder has 1-10 wt % of said total weight.

In one embodiment, the superconductor powder comprises one or more mixtures of La2-x-ySrxBayCuO4, La2-x-y BixSryCuO4, La2-x-y-z BixSryCaZCuO4, La2-x-y-z HgxBayCazCuO4, La2-x-ySrxTlyBazCuO6, La2-x-y-z-wSrxTlyBazCawCu2O8, HgBa2Ca2Cu3O8, where each of x, y, z, and w is between 0.1 and 0.9.

In one embodiment, the superconductor-metal conductive material is formed by following steps: mixing 50-95 weight percentage of metal powder and 4-40 weight percentage of superconductor powder; adding 1-10 weight percentage of organic carrier adhesive to the mixed powder; adding the mixture into a solvent containing dispersant to obtain the superconductor-metal conductive material.

Some examples for preparation of conductive paste are described as follows.

Example 1: preparation of conductive paste. The superconductor-metal conductive material is formed by following steps: step 1: processing silver (Ag) powder: the processed Ag powder has an average particle size ranging from 50 nm to 5 μm. Among this, particles smaller than 100 nm account for 30%, and the remaining particles between 100 nm and 5 μm account for 70%; processing superconductor La2-x-ySrxTlyBazCuO6: the processed superconductor powder has an average particle size between 30 nm and 500 nm; step 3: mixing: take 80 wt % of Ag powder and 20 wt % of La2-x-ySrxTlyBazCuO6, and mix the superconductor powder uniformly, wherein the ranges for the variables are: 0.2<x<0.8, 0.3<y<0.7, 0.2<z<0.6; step 4: mix the superconductor powder uniformly; step 5: adding binder: add 5-10 wt % (relative to the solid metal and superconductor powder) of the binder polyvinyl butyral (PVB); add an alcohol and butyl acetate mixed solvent containing 1-10 wt % BYK110 dispersant; stir and mix uniformly to obtain the conductive paste; step 6: applying and sintering: attach the conductive paste to the ceramic body using a certain method to form a dielectric layer; and sinter at a temperature above 850° C. for 2 hours.

Usage: use the resulting ceramic electronic component in a cryogenic environment (77K to 223K) with liquid nitrogen. The superconductor powder contributes to the conductive path, reducing the resistance value to 1×10⁻⁴ Ω·cm. Additionally, the component's energy consumption is reduced by approximately 30%.

Example 2: Preparation of Conductive Paste: The superconductor-metal conductive material is formed by following steps: step 1: processing palladium (Pd): The processed Pd powder has an average particle size ranging from 50 nm to 3 μm. Among this, particles smaller than 100 nm account for 20%, and the remaining particles between 100 nm and 3 μm account for 80%; step 2: processing superconductor Bi2Sr2CaCu2O8: The processed superconductor powder has an average particle size between 50 nm and 300 nm; step 3: mixing: take 80 wt % Ag powder, 10 wt % HgBa2Ca2Cu3O8 superconductor powder, and 10 wt % Bi2Sr2CaCu2O8 superconductor powder; mix the powders uniformly; step 4: adding binder: add 5-10 wt % (relative to the solid metal and superconductor powder) of the binder ethyl cellulose, add a butyl acetate and ethylene glycol monobutyl ether mixed solvent containing 1-10 wt % BYK163 dispersant, and stir and mix uniformly to obtain the conductive paste; step 5: applying and sintering: attach the conductive paste to the ceramic body using a certain method to form a dielectric layer. Sinter at a temperature above 950° C. for 2 hours.

Usage: use the resulting ceramic electronic component in a cryogenic environment (77K to 223K) with liquid nitrogen. The superconductor powder contributes to the conductive path, reducing the resistance value to 1×10⁻⁴ Ω·cm. Additionally, the component's energy consumption is reduced by approximately 35%.

Example 3: Preparation of Conductive Paste: The superconductor-metal conductive material is formed by following steps: step 1: processing Ag/Ti: the processed Ag/Ti powder has an average particle size ranging from 50 nm to 3 μm. Among this, particles smaller than 100 nm account for 20%, and the remaining particles between 100 nm and 3 μm account for 80%; step 2: processing Superconductor Tl2Ba2CaCu2O8: the processed superconductor powder has an average particle size between 50 nm and 300 nm. Step 3: mixing: take 80 wt % Ag/Ti powder, 10 wt % HgBa2Ca2Cu3O8 superconductor powder, and 10 wt % Tl2Ba2CaCu2O8 superconductor powder and mix the powders uniformly; step 4: adding binder: add 5-10 wt % (relative to the solid metal and superconductor powder) of the binder ethyl cellulose, add a mixed solvent of diethylene glycol monobutyl ether and terpineol containing 1-10 wt % BYK110 dispersant, and stir and mix uniformly to obtain the conductive paste; step 5: applying and sintering: attach the conductive paste to the ceramic body using a certain method to form a dielectric layer. Sinter at a temperature above 850° C. for 2 hours.

Usage: use the resulting ceramic electronic component in a cryogenic environment (77K to 223K) with liquid nitrogen. The superconductor powder contributes to the conductive path, reducing the resistance value to 1×10⁻⁴ Ω·cm. Additionally, the component's energy consumption is reduced by approximately 30%.

The resistance value is measured as follows: square resistance, where square resistance refers to the resistance from edge to edge of a square sample to be measured, is only related to the resistivity and thickness of the sample. The calculation formula is: R=p/d, p is the resistivity of the material, and d is the thickness of the sample. The four-probe method is usually used for measurement. The relationship is R=V/I·F(D/S)·F(W/S)·Fsp, wherein I is the current value flowing through the two probes at the outer end, and V is the inner, wherein the voltage values between the probes, F(D/S), F(W/S) and Fsp are the correction factors of the instrument. During the test, a certain current is applied between the probes at both ends of the instrument, and the square resistance value of the material is obtained by obtaining the potential difference between the two probes at the inner end.

Manufacturing method: preparation of conductive paste: processing metal into powder: convert the metal into powder form, processing superconductor into powder: convert the superconductor into powder form; mixing: take 80 wt % metal powder and 20 wt % superconductor powder and mix them uniformly; adding binder and dispersant: add 5-10 wt % (relative to the solid metal and superconductor powder) of the binder and stir uniformly; add the dispersant and stir to mix uniformly to obtain the conductive paste; applying and sintering: attach the conductive paste to the ceramic body to form a dielectric layer and sinter at a temperature above 800° C. for 30 minutes.

Usage: use the resulting ceramic electronic component in a cooling environment with liquid nitrogen (77K to 223K). The superconductor powder enhances the conductive path, reducing the resistance value to 1×10⁻⁴ Ω·cm. Additionally, the component's energy consumption is reduced by approximately 30%.

The resistance value is measured as follows: Square resistance, where square resistance refers to the resistance from edge to edge of a square sample to be measured, is only related to the resistivity and thickness of the sample. The calculation formula is: R=p/d, p is the resistivity of the material, and d is the thickness of the sample. The four-probe method is usually used for measurement. The relationship is R=V/I·F(D/S)·F(W/S)·Fsp, wherein I is the current value flowing through the two probes at the outer end, and V is the inner, wherein the voltage values between the probes, F(D/S), F(W/S) and Fsp are the correction factors of the instrument. During the test, a certain current is applied between the probes at both ends of the instrument, and the sheet resistance value of the material is obtained by obtaining the potential difference between the two probes at the inner end.

The present invention discloses a method for preparing a ceramic electronic component having the superconductor-metal conductive material by the following steps: Step 01: coating the superconductor-metal conductive material on a ceramic layer to form a dielectric/ceramic composite layer; step 02: stacking multiple ceramic bodies with dielectric layers together, and sintering at a temperature above 800° C. to obtain a multilayer ceramic electronic component.

The present invention discloses a method for preparing a superconductor-metal conductive material by the following steps: step 01: mixing 50-95 weight percentage of metal powder and 4-40 weight percentage of superconductor powder; step 02: adding 1-10 weight percentage of organic carrier adhesive to the mixed powder; step 03: adding the mixture into a solvent containing dispersant, mixing, and stirring evenly to obtain a slurry of metal conductive material.

Compared with the prior art, the invention has the following advantages: (1) The ceramic electronic component prepared by this invention can be used in liquid nitrogen cooling environments (77K to 223K), the superconductor powder contributes to the conductive path, significantly reducing the resistance value to a minimum of 1*10⁻⁴ Ω·cm, and greatly reducing the energy consumption of the component; (2) The metal composite conductive slurry prepared by this invention can be used for the inner layer electrodes and end electrodes of passive components such as chip varistors, thermistors, multilayer ceramic capacitors, multilayer inductors, and chip resistors. As the operating temperature of superconducting oxides gradually increases, when used at an absolute temperature of 200K, it can maintain the original performance of the passive components. Additionally, the superconducting oxide provides an impedance-free circuit path, reducing the energy loss and failure probability of the operating components, thereby greatly improving the reliability of passive component products in harsh low-temperature environments; (3) This invention has the advantage of improving the reliability of passive component products in harsh low-temperature environments. By replacing glass powder with superconducting oxide and using the expansion coefficient of the superconducting oxide to adjust the expansion coefficient of the metal composite slurry formed by the metal conductor to match the ceramic material, it can reduce the impedance value of the metal composite slurry and increase the reliability at high temperatures.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A superconductor-metal conductive material, comprising a metal powder, a superconductor powder and an organic carrier adhesive, wherein the metal powder has 50˜95 wt % of a total weight of said metal powder, said superconductor powder and said organic carrier binder, the superconductor powder has 4˜40 wt % of said total weight, and the organic carrier binder has 1-10 wt % of said total weight, wherein the superconductor powder comprises one or more of the following mixtures:
La2-x-ySrxBayCuO4, La2-x-y BixSryCuO4, La2-x-y-z BixSryCaZCuO4, La2-x-y-z HgxBayCazCuO4, La2-x-ySrxTlyBazCuO6, La2-x-y-z-wSrxTlyBazCawCu2O8, and HgBa2Ca2Cu3O8, where each of x, y, z, and w is between 0.1 and 0.9.

2. The superconductor-metal conductive material according to claim 1, wherein the average particle size of the superconductor powder is 30 nm to 300 nm.

3. The superconductor-metal conductive material according to claim 1, wherein the metal powder comprises one or more mixtures of Au, Ag, Cu, Sn, Ag/Pd, Pd, Al, Nb, Ti, and Ni.

4. The superconductor-metal conductive material according to claim 1, wherein the average particle size of the metal powder is 30 nm to 2 μm.

5. The superconductor-metal conductive material according to claim 1, wherein the particle size of the metal powder is less than 100 nm for 10-20% of all of the particles of the metal powder, and the particle size of the metal powder is between 100 nm and 2 μm for 80-90% of all of the particles of the metal powder.

6. The superconductor-metal conductive material according to claim 1, wherein the organic carrier adhesive comprises one or more mixtures of polyvinyl butyral, ethyl cellulose, polyvinyl acetate, polyethylene oxide, carboxymethyl cellulose, styrene-butadiene rubber, polyacrylic acid, and polymethyl methacrylate.

7. The superconductor-metal conductive material according to claim 1, wherein the superconductor-metal conductive material further comprises a organic solvent, wherein the organic solvent is one or more mixtures of toluene, alcohol, butyl acetate, ethylene glycol monobutyl ether, diethylene glycol monobutyl ether, and terpineol.

8. The superconductor-metal conductive material according to claim 1, wherein it further includes a dispersant, which comprises one or more mixtures of carboxylic acid type, long-chain alkyl amino acid type, polyacrylic acid type, and polymethyl methacrylate type.

9. An electronic component, comprising: a plurality of composite layers stacked together, wherein each composite layer comprises a ceramic layer and a conductive layer made of a superconductor-metal conductive material is coated on the ceramic layer, wherein the superconductor-metal conductive material, comprising a metal powder, a superconductor powder and an organic carrier adhesive, wherein the metal powder has 50˜95 wt % of a total weight of said metal powder, said superconductor powder and said organic carrier binder, the superconductor powder has 4˜40 wt % of said total weight, and the organic carrier binder has 1-10 wt % of said total weight, wherein the superconductor powder comprises one or more of the following mixtures:
La2-x-ySrxBayCuO4, La2-x-y BixSryCuO4, La2-x-y-z BixSryCaZCuO4, La2-x-y-z HgxBayCazCuO4, La2-x-ySrxTlyBazCuO6, La2-x-y-z-wSrxTlyBazCawCu2O8, and HgBa2Ca2Cu3O8, where each of x, y, z, and w is between 0.1 and 0.9.

10. The electronic component according to claim 9, wherein the average particle size of the superconductor powder is 30 nm to 300 nm.

11. The electronic component according to claim 9, wherein the metal powder includes one or more mixtures of Au, Ag, Cu, Sn, Ag/Pd, Pd, Al, Nb, Ti, and Ni.

12. The electronic component according to claim 9, wherein the average particle size of the metal powder is 30 nm to 2 μm.

13. The electronic component according to claim 9, wherein the particle size of the metal powder is less than 100 nm for 10-20% of all of the particles of the metal powder, and the particle size of the metal powder is between 100 nm and 2 μm for 80-90% of all of the particles of the metal powder.

14. The electronic component according to claim 9, wherein the electronic component is a resistor.

15. The electronic component according to claim 9, wherein the electronic component is a varistor.

16. A method for forming an electronic component, comprising: coating a superconductor-metal conductive material on a ceramic layer to form a composite layer; stacking multiple composite layers together and sintering the stacked multiple composite layers at a temperature above 800° C. to obtain the ceramic electronic component, wherein the superconductor-metal conductive material, comprising a metal powder, a superconductor powder and an organic carrier adhesive, wherein the metal powder has 50˜95 wt % of a total weight of said metal powder, said superconductor powder and said organic carrier binder, the superconductor powder has 4˜40 wt % of said total weight, and the organic carrier binder has 1-10 wt % of said total weight, wherein the superconductor powder comprises one or more of the following mixtures:
La2-x-ySrxBayCuO4, La2-x-y BixSryCuO4, La2-x-y-z BixSryCaZCuO4, La2-x-y-z HgxBayCazCuO4, La2-x-ySrxTlyBazCuO6, La2-x-y-z-wSrxTlyBazCawCu2O8, and HgBa2Ca2Cu3O8, where each of x, y, z, and w is between 0.1 and 0.9.

17. The method according to claim 16, wherein the superconductor-metal conductive material is formed by following steps: mixing 50-95 weight percentage of metal powder and 4-40 weight percentage of superconductor powder; adding 1-10 weight percentage of organic carrier binder to the mixed powder; adding the mixture into a solvent containing dispersant to obtain the superconductor-metal conductive material.
